(19) United States
(12) Patent Application Publication
(10) Pub. No.: US 2021/0162296 A1
(43) Pub. Date: Jun. 3, 2021

(54) METHOD AND DEVICE FOR CONTROLLING VIRTUAL OBJECT, ELECTRONIC DEVICE AND STORAGE MEDIUM

(71) Applicant: NETEASE (HANGZHOU) NETWORK CO.,LTD., Hangzhou (CN)

(72) Inventors: Yajia LIN, Hangzhou (CN); Yudong XIANG, Hangzhou (CN); Wei CHEN, Hangzhou (CN)

(73) Assignee: NETEASE (HANGZHOU) NETWORK CO.,LTD., Hangzhou (CN)

(21) Appl. No.: 17/047,752

(22) PCT Filed: Oct. 30, 2018
(86) PCT No.: PCT/CN2018/112734

§ 371 Date: Oct. 15, 2020

(30) Foreign Application Priority Data
Jun. 22, 2018 (CN) 201810652486.5

(51) Int. Cl. A63F 13/2145; A63F 13/55

(52) U.S. Cl. CPC A63F 13/2145; A63F 13/55

(57) ABSTRACT

A method for controlling a virtual object in which a graphical user interface comprising a game scenario and at least one virtual object is rendered by performing a game application includes: providing a forward control area and a backward control area on the graphical user interface, and controlling the virtual object to move forward, to move backward, to turn left forward, to turn right forward, to turn left backward or to turn right backward according to different touch control operations detected on the two control areas.

### CROSS-REFERENCE TO RELATED APPLICATIONS

The present application is the 371 application of PCT Application No. PCT/CN2018/112734, filed on Oct. 30, 2018, which is based on and claims priority to Chinese Patent Application No. 201810652486.5, filed on Jun. 22, 2018, the entire contents of both of which are incorporated herein by reference.

### TECHNICAL FIELD

The present disclosure relates to the field of human-computer interaction technologies, and in particular, to a method and device for controlling a game virtual object, an electronic device, and a computer readable storage medium.

### BACKGROUND

In game products of a mobile terminal, for a control interface of a game related to driving tools, a joystick operation mode is generally used in the related art, which is similar to operation of an arcade movable joystick of the last century in which a control is pressed in the center and then pushed to the periphery with a range of 360 degrees, thereby controlling a game character to move in a corresponding direction. The joystick operation has a delicate direction correspondence, which is more suitable for the movement control of a biological game character, but is not suitable for conventional vehicles which have settings of moving forward, moving backward, turning left and turning right. Applying the joystick operation to the steering of the vehicles is prone to confuse a player with the joystick operation experience for the biological game character. For example, for a pull-down operation of the joystick, it corresponds to turning around and going on for the biological game character, and corresponds to reversing for the vehicles, which are of completely different operating experience.

It should be noted that the information disclosed in the Background above is only for enhancing the understanding of the background of the present disclosure, and thus may include information that does not constitute prior art known to those of ordinary skill in the art.

### SUMMARY

According to an aspect of the present disclosure, there is provided a method for controlling a virtual object, in which a graphical user interface including a game scenario and at least one virtual object is rendered by performing a game application, the method including:

providing a forward control area and a backward control area on the graphical user interface; controlling the virtual object to move forward when a first preset touch control operation is detected on the forward control area; and controlling the virtual object to move backward when the first preset touch control operation is detected on the backward control area; and

controlling the virtual object to turn left forward when a second preset touch control operation which slides from the forward control area to the left is detected controlling the virtual object to turn right forward when the second preset touch control operation which slides from the forward control area to the right is detected; controlling the virtual object to turn left backward when the second preset touch control operation which slides from the backward control area to the left is detected; and controlling the virtual object to turn right backward when the second preset touch control operation which slides from the backward control area to the right is detected.

An aspect of the present disclosure also provides a device for controlling a virtual object, in which a graphical user interface including a game scenario and at least one virtual object is rendered by performing a game application, the device including:

a longitudinal movement control module, configured to provide a forward control area and a backward control area on the graphical user interface; control the virtual object to move forward when a first preset touch control operation is detected on the forward control area; and control the virtual object to move backward when the first preset touch control operation is detected on the backward control area; and

a turning control module, configured to control the virtual object to turn left forward when a second preset touch control operation which slides from the forward control area to the left is detected; control the virtual object to turn right forward when the second preset touch control operation which slides from the forward control area to the right is detected; control the virtual object to turn left backward when the second preset touch control operation which slides from the backward control area to the left is detected; and control the virtual object to turn right backward when the second preset touch control operation which slides from the backward control area to the right is detected.

An aspect of the present disclosure also provides a mobile terminal, including: a processor; and a memory for storing instructions executable by the processor, wherein the processor is configured to perform the method described above by executing the executable instructions.

An aspect of the present disclosure also provides a computer readable storage medium having stored thereon a computer program which, when being executed by a processor, performs the method described above.

It should be noted that the above general description and the following detailed description are merely exemplary and explanatory and should not be construed as limiting of the disclosure.

### BRIEF DESCRIPTION OF THE DRAWINGS

The accompanying drawings, which are incorporated in the specification and constitute a part of the specification, illustrates embodiments in consistent with the present disclosure. The drawings along with the specification explain the principles of the present disclosure. It is apparent that the drawings in the following description show only some of the embodiments of the present disclosure, and other drawings can be obtained by those skilled in the art based on the drawings without any creative work.

FIG. 1 is a flowchart showing a method for controlling a virtual object in an exemplary embodiment of the present disclosure;

FIG. 2 is a schematic diagram showing a method for controlling a virtual object in an exemplary embodiment of the present disclosure;

FIG. 3 is a schematic diagram showing a method for controlling a virtual object in an exemplary embodiment of the present disclosure;

FIG. 4 is a schematic diagram showing a method for controlling a virtual object in an exemplary embodiment of the present disclosure;

FIG. 5 is a schematic diagram showing a method for controlling a virtual object in an exemplary embodiment of the present disclosure;

FIG. 6 is a schematic diagram showing a method for controlling a virtual object in an exemplary embodiment of the present disclosure;

FIG. 7 is a schematic diagram showing a method for controlling a virtual object in an exemplary embodiment of the present disclosure;

FIG. 8 is a schematic diagram showing a method for controlling a virtual object in an exemplary embodiment of the present disclosure;

FIG. 9 is a schematic structural diagram showing a device for controlling a virtual object in an exemplary embodiment of the present disclosure;

FIG. 10 is a schematic structural diagram showing a mobile terminal for implementing the above method in an exemplary embodiment of the present disclosure; and

FIG. 11 is a schematic structural diagram showing a computer readable storage medium for implementing the above method in an exemplary embodiment of the present disclosure.

### DETAILED DESCRIPTION

Example embodiments will now be described more fully with reference to the accompanying drawings. However, the embodiments can be implemented in a variety of modes and should not be construed as being limited to the examples set forth herein. Rather, these embodiments are provided so that this disclosure will be more complete and the idea of the exemplary embodiments will be conveyed to those skilled in this art. The described features, structures, or characteristics can be combined in one or more embodiments in any suitable manner.

In view of the above problems, an embodiment of the present application provides a method for controlling a virtual object. In this embodiment, the method for controlling the virtual object is illustrated by way of different examples. The method for controlling the virtual object provided in this embodiment is performed on a mobile terminal device including a touch display screen, and the mobile terminal device can be an electronic terminal device such as a computer, a tablet computer, a mobile phone, or the like. A graphical user interface is rendered by performing a game application, and content displayed by the graphical user interface includes, at least in part, a partial or full game scenario, and the game scenario includes at least one virtual object. As shown in FIG. 2, a game scenario (not specifically shown in the figure) and a virtual object 2 (virtual objects controlled by other game users not shown in the figure) are included in the graphical user interface 1. The virtual object can make corresponding response according to the received control instructions, for example, releasing skills or moving. The control instructions are various instructions triggered by performing different touch control operations on the graphical user interface by the game user.

The game scenario can include virtual resources with relatively fixed locations, such as the ground, mountains, rocks, flowers, grass, trees, buildings, and the like. The virtual object can be either a virtual object of an enemy camp, or a virtual object of the own camp. The virtual object can perform corresponding actions in the game scenario in response to the user's operation. For example, the user may control the virtual object to perform various actions in the game scenario such as moving, advancing, retreating, turning, attacking, shooting, etc., which is not limited herein.

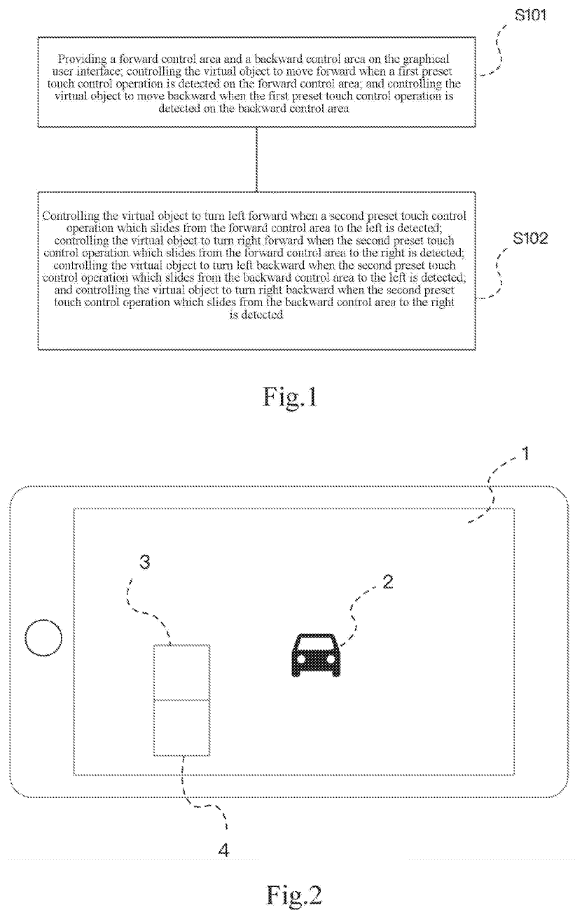

Various steps in the method for controlling the virtual object provided in this embodiment can be performed step by step according to the received touch control operation, or subsequent steps can be automatically performed after the method provided by the embodiment is triggered. The various steps can be performed in sequence, or part or all of the steps can be performed simultaneously. The specific order of the steps is not specifically limited, and adaptive adjustment and setting can be made according to actual conditions. As shown in FIG. 1, the method for controlling the virtual object provided by this embodiment includes the following steps.

In step S101, a forward control area and a backward control area are provided on the graphical user interface, the virtual object is controlled to move forward when a first preset touch control operation is detected on the forward control area, and the virtual object is controlled to move backward when the first preset touch control operation is detected on the backward control area.

In step S102, the virtual object is controlled to turn left forward when a second preset touch control operation which slides from the forward control area to the left is detected; the virtual object is controlled to turn right forward when the second preset touch control operation which slides from the forward control area to the right is detected; the virtual object is controlled to turn left backward when the second preset touch control operation which slides from the backward control area to the left is detected; and the virtual object is controlled to turn right backward when the second preset touch control operation which slides from the backward control area to the right is detected.

The first preset touch control operation performed on the forward control area and the backward control area can be long pressing, clicking, sliding, or the like. However, in order to be distinguished from the second preset touch control operation for controlling the turning of the virtual object, the first preset operation cannot be a lateral sliding touch control operation. The second preset touch control operation is the lateral sliding touch control operation, and the lateral direction is not limited to the direction parallel to a horizontal axis of the screen, as long as the direction of the sliding touch control operation includes a lateral component. The second preset touch control operation can be a simple lateral sliding touch control operation, or a sliding touch control operation in which a displacement in the lateral direction exceeds a preset length, or can be a sliding touch control operation moving out of the forward control area or the backward control area. It should be noted that the first preset touch control operation and the second preset touch control operation can be two separate touch control operations, or can be one consecutive touch control operation. For example, a long press operation is performed on the forward control area first to control the virtual object to move forward, and then the operation slides out of the forward control area from left so as to control the virtual object to turn left forward.

As shown in FIG. 2, the graphical user interface 1 provides a forward control area 3 and a backward control area 4. When a first preset touch control operation (such as a long press) performed on the forward control area 3 is detected, the virtual object 2 is controlled to move forward. When the first preset touch control operation (such as the long press) performed on the backward control area 4 is detected, the virtual object 2 is controlled to move backward.

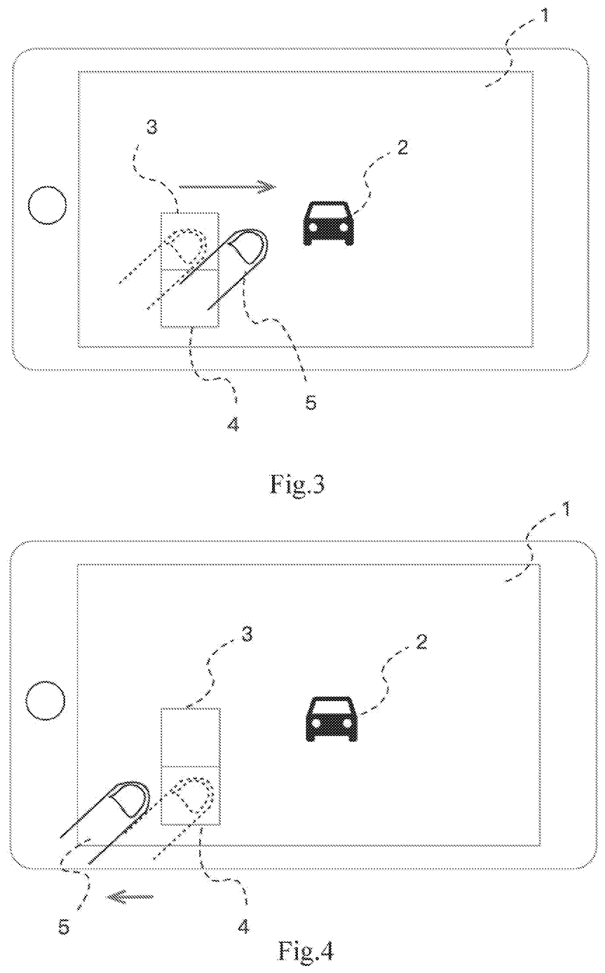

In a specific embodiment, when a sliding touch control operation of which a touch start point is located in the forward control area 3 and which moves out of the forward control area 3 to the left is detected, the virtual object 2 is controlled to turn left forward; and when the sliding touch control operation of which the touch start point is located in the forward control area 3 and which moves out of the forward control area 3 to the right is detected, as shown in FIG. 3, the virtual object 2 is controlled to turn right forward. When the sliding touch control operation of which the touch start point is located in the backward control area 4 and which moves out of the backward control area 4 to the left is detected, the virtual object 2 is controlled to turn left backward; and when the sliding touch control operation of which the touch start point is located in the backward control area 4 and which moves out of the backward control area 4 to the right is detected, the virtual object 2 is controlled to turn right backward.

The shape of the forward control area 3 and the backward control area 4 is not limited to the square shown in FIG. 2, and can also be a rectangle, a circle, a curved shape, a sector, or the like. The relative positions of the forward control area 3 and the backward control area 4 are not limited to those shown in FIG. 2, and there can also be other relative positional relationships. For example, the forward control area 3 and the backward control area 4 can also be located at the same height in the graphical user interface. The forward control area 3 can be on the left side or on the right side of the backward control area 4.

The forward control area 3 and the backward control area 4 can be set to be visible or invisible. Displaying each of the control areas by the contour lines shown in FIG. 2 is only one of many visible ways, and there can be other ways, such as displaying the respective control areas semi-transparently in the graphical user interface, or displaying only the spacing line between the control areas.

According to the above embodiments, the forward control area and the backward control area are provided on the graphical user interface. According to the detected different touch control operations performed on the above two control areas, the virtual object is controlled to move forward, move backward, turn left forward, turn right forward, turn left backward and turn right backward, thereby providing the game user with control experience which is closer to that of steering a real vehicle in the game scenario, not confusing the game user with the common movement control operations of the biological virtual objects, and making it easier for new users to start playing.

In another embodiment, the forward control area is positioned above the backward control area on the graphical user interface, which indicates that the forward control area is in front of the backward control area on the graphical user interface from the perspective of the user. As shown in FIG. 2, the forward control area 3 is located above the backward control area 4 in the graphical user interface 1, which allows the user to control the virtual object to move forward and move backward in a way which conforms to a general perception of advancing and retreating.

In another embodiment, a distance between the forward control area and the backward control area is within a preset distance range, and the preset distance range is configured to ensure that a user can touch and control with one hand.

As shown in FIG. 2, the distance between the forward control area 3 and the backward control area 4 is 0, that is, the two control areas border with each other. Of course, the distance between the two control areas can also be greater than 0, such as 1 cm, as long as the two control areas can be touched respectively by the user's finger of one hand for touch (such as the left thumb) during the game operation.

In another embodiment, a visual prompt control is provided on at least one of the forward control area, the backward control area, a left side of the forward control area, a right side of the forward control area, a left side of the backward control area, and a right side of the backward control area.

As shown in FIG. 5, there are a forward prompt control in the forward control area 3 and a backward prompt control in the backward control area 4. The appearance of the visual prompt control is not limited to the arrows shown in FIG. 5, and can be other patterns such as triangles, characters, and the like.

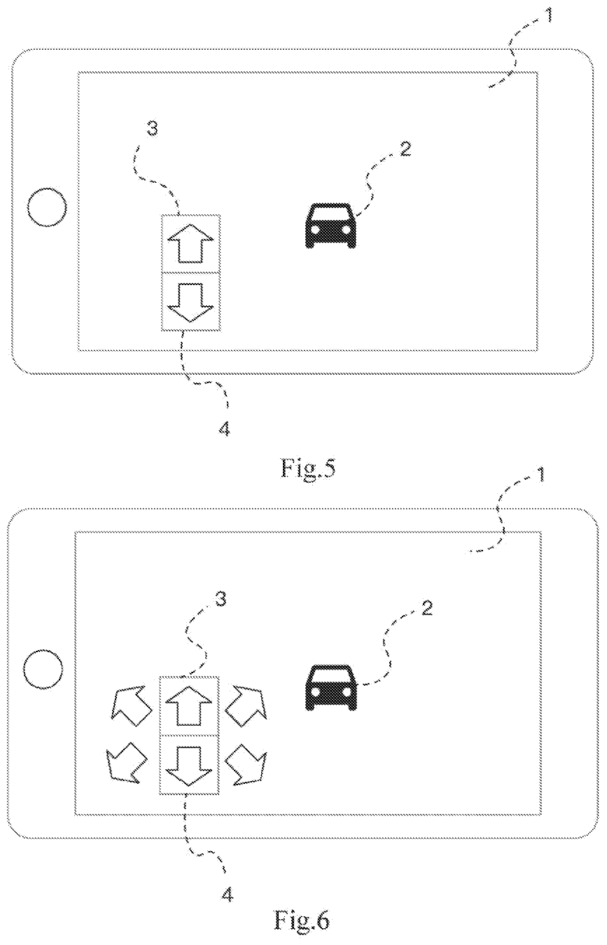

As shown in FIG. 6, there are a forward prompt control in the forward control area 3, a backward prompt control in the backward control area 4, a turning left forward prompt control disposed on the left side of the forward control area 3, a turning right forward prompt control disposed on the right side of the forward control area 3, a turning left backward prompt control disposed on the left side of the backward control area 4, and a turning right backward prompt control disposed on the right side of the backward control area 4.

In addition to the specific situations shown in FIG. 5 and FIG. 6, it is also possible that there is only a visual prompt control in the forward control area 3, or there is only a visual prompt control in the backward control area 4.

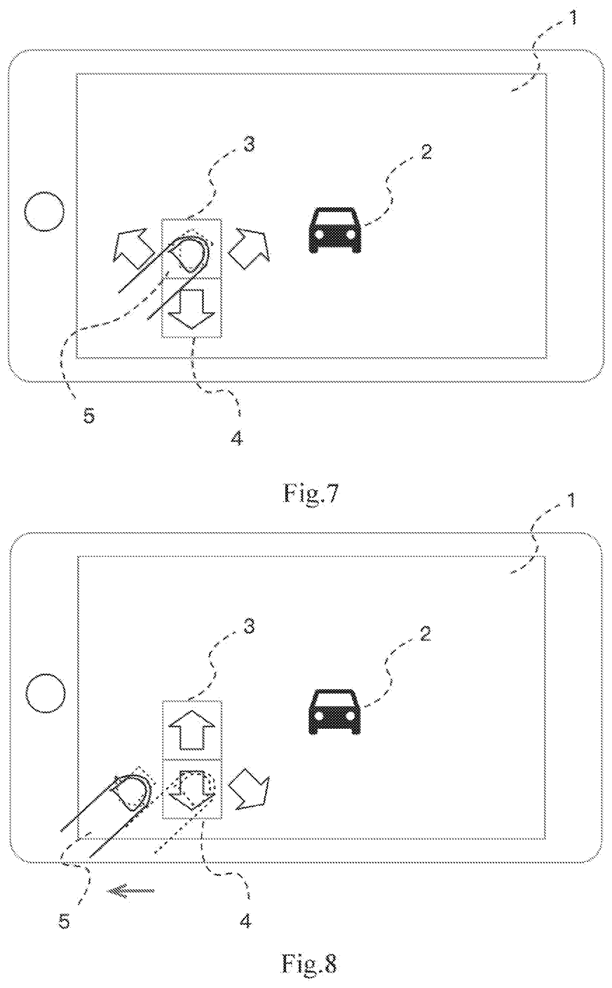

In another embodiment, the method further includes: providing a forward visual prompt control in the forward control area and displaying a turning visual prompt control on the left and right sides of the forward control area, respectively, when a touch control operation in which at least part of touch points are located in the forward control area is detected. As shown in FIG. 7, there is shown a forward visual prompt control in the forward control area 3. When the user's finger 5 touches the forward control area 3, the turning left forward prompt control and the turning right forward prompt control are respectively displayed on the left and right sides of the forward control area 3. When the user does not perform the forward control operation on the virtual object, the turning visual prompt controls will not be displayed on the graphical user interface, and when the user is performing the forward control operation, the turning visual prompt controls are displayed, thereby not only ensuring the simplicity of the graphical user interface but also prompting that the turning is possible when the user is performing the forward control operation.

Further, the method further includes: stopping the displaying of the turning visual prompt controls when it is detected that the touch control operation in which at least part of the touch points are located in the forward control area ends. When it is detected that the touch control operation in which at least part of the touch points are located in the forward control area 3 ends (for example, the finger 5 long-pressing the forward control area 3 lifts up), the turning prompt controls are no longer displayed, as shown in FIG. 5, so that the graphical user interface is concise.

In another embodiment, the method further includes: providing a backward visual prompt control in the backward control area; and displaying a turning visual prompt control on the left and right sides of the backward control area, respectively, when a touch control operation in which at least part of touch points are located in the backward control area is detected. As shown in FIG. 8, there is shown a visual prompt control in the backward control area 4. When the user's finger 5 touches the backward control area 4, the turning left backward prompt control and the turning right backward prompt control are respectively displayed on the left and right sides of the backward control area 4. When the user does not perform the backward control operation on the virtual object, the turning visual prompt controls are not displayed on the graphical user interface, and when the user is performing the backward control operation, the turning visual prompt controls are displayed, thereby not only ensuring the simplicity of the graphical user interface but also prompting that the turning is possible when the user is performing the backward control operation.

Further, the method further includes: stopping the displaying of the turning visual prompt control when it is detected that the touch control operation in which at least part of touch points are located in the backward control area ends. When it is detected that the touch control operation in which at least part of the touch points are located in the backward control area 4 ends (for example, the finger 5 long-pressing the backward control area 4 lifts up), the turning prompt controls are no longer displayed, as shown in FIG. 5, so that the graphical user interface is concise.

In another embodiment, the method further includes at least one of the following:

adjusting a forward turning angle of the virtual object according to a first lateral distance between a real-time position of a touch point and the forward control area when the second preset touch control operation which slides from the forward control area to the left or to the right is detected; and adjusting a backward turning angle of the virtual object according to a second lateral distance between the real-time position of the touch point and the backward control area when the second preset touch control operation which slides from the backward control area to the left is detected or to the right.

In this embodiment, when the virtual object is controlled to turn left forward or turn right forward by the user, the first lateral distance between the touch point and the forward control area is detected. The larger the first lateral distance is, the larger the turning angle of the virtual object is (the farther the touch point goes to the left, the greater the angle at which the virtual object turns left forward is: the farther the touch point goes to the right, the greater the angle at which the virtual object turns right forward is). Similarly, when the virtual object is controlled to turn left backward or to turn right backward by the user, the second lateral distance between the touch point and the backward control area is detected. The larger the second lateral distance is, the larger the turning angle of the virtual object is (the farther the touch point goes to the left, the greater the angle at which the virtual object turns left backward is; the farther the touch point goes to the right, the greater the angle at which the virtual object turns right backward is).

The relationship between the turning angle and the first lateral distance and the relationship between the turning angle and the second lateral distance can be a linear proportional relationship, a nonlinear positive correlation relationship, or a relationship similar to energy level transition (for example, when the lateral sliding distance is greater than 0 and less than 5 mm, the turning angle is 5 degrees; when the lateral sliding distance is greater than or equal to 5 mm and less than 10 mm, the turning angle is 10 degrees; when the sliding distance is greater than or equal to 10 mm and less than 15 mm, the turning angle is 15 degrees; and so on). Obviously, there is a limit on the turning angle. When the turning angle reaches the limit, even if the sliding distance (i.e., the first lateral distance and the second lateral distance) continues to increase, the turning angle does not increase any more.

The first lateral distance between the real-time position of the touch point and the forward control area can be a distance from the real-time position of the touch point to the center of the forward control area, or a distance from the real-time position of the touch point to the left or right side of the forward control area. Similarly, the second lateral distance between the real-time position of the touch point and the backward control area can be a distance from the real-time position of the touch point to the center of the backward control area, or a distance from the real-time position of the touch point to the left or right side of the backward control area.

In this embodiment, the user can control the turning angle of the virtual object by controlling the lateral distance of the touch point from the forward control area or from the backward control area during the process of controlling the turning of the virtual object, thereby enriching the control modes while improving the immersion feeling of the game for the user.

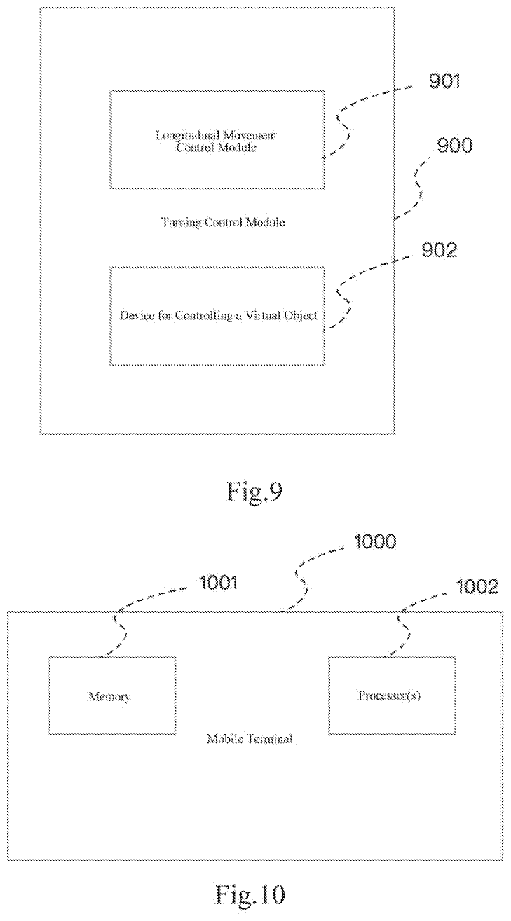

As shown in FIG. 9, the present exemplary embodiment further provides a device 900 for controlling a virtual object, a graphical user interface including a game scenario and at least one virtual object is rendered by performing a game application, and the device 900 includes:

a longitudinal movement control module 901, configured to provide a forward control area and a backward control area on the graphical user interface; control the virtual object to move forward when a first preset touch control operation is detected on the forward control area; and control the virtual object to move backward when the first preset touch control operation is detected on the backward control area; and

a turning control module 902, configured to control the virtual object to turn left forward when a second preset touch control operation which slides from the forward control area to the left is detected; control the virtual object to turn right forward when the second preset touch control operation which slides from the forward control area to the right is detected; control the virtual object to turn left backward when the second preset touch control operation which slides from the backward control area to the left is detected; and control the virtual object to turn right backward and right when the second preset touch control operation which slides from the backward control area to the right is detected.

The specific details of each module unit in the foregoing embodiment have been described in the corresponding method for controlling the virtual object. In addition, it can be understood that the device for controlling the virtual object further includes other unit modules corresponding to the information processing method, and therefore will not be described herein.

It should be noted that although several modules or units of devices for performing actions are described above, such division of modules or units is not mandatory. In fact, features and functions of two or more of the modules or units described above may be embodied in one module or unit in accordance with the embodiments of the present disclosure. Alternatively, the features and functions of one module or unit described above may be further divided into multiple modules or units.

FIG. 10 is a schematic structural diagram of a mobile terminal according to an embodiment of the present disclosure. As shown in FIG. 10, the mobile terminal 1000 of this embodiment includes a memory 1001 and a processor 1002. The memory 1001 and the processor 1002 can be connected by a bus.

The processor is configured to perform the following steps by executing executable instructions:

rendering a graphical user interface by performing a game application, wherein the graphical user interface includes a game scenario and at least one virtual object;

providing a forward control area and a backward control area on the graphical user interface; controlling the virtual object to move forward when a first preset touch control operation is detected on the forward control area; and controlling the virtual object to move backward when the first preset touch control operation is detected on the backward control area; and

controlling the virtual object to turn left forward when a second preset touch control operation which slides from the forward control area to the left is detected; controlling the virtual object to turn right forward when the second preset touch control operation which slides from the forward control area to the right is detected; controlling the virtual object to turn left backward when the second preset touch control operation which slides from the backward control area to the left is detected; and controlling the virtual object to turn right backward when the second preset touch control operation which slides from the backward control area to the right is detected.

Optionally, a position of the forward control area on the graphical user interface is higher than that of the backward control area.

Optionally, a distance between the forward control area and the backward control area is within a preset distance range, and the preset distance range is configured to ensure that a user can touch and control with one hand.

Optionally, the processor is further configured to:

provide a visual prompt control on at least one of the forward control area, the backward control area, a left side of the forward control area, a right side of the forward control area, a left side of the backward control area, and a right side of the backward control area.

Optionally, the processor is further configured to:

provide a forward visual prompt control in the forward control area; and

display a turning visual prompt control on left and right sides of the forward control area, respectively, when a touch control operation in which at least part of touch points are located in the forward control area is detected.

Optionally, the processor is further configured to:

stop the displaying of the turning visual prompt controls when detecting that the touch control operation in which at least part of touch points are located in the forward control area ends.

Optionally, the processor is further configured to:

provide a backward visual prompt control in the backward control area and

display a turning visual prompt control on left and right sides of the backward control area, respectively, when a touch control operation in which at least part of touch points are located in the backward control area is detected.

Optionally, the processor is further configured to:

stop the displaying of the turning visual prompt control when it is detected that the touch control operation in which at least part of touch points are located in the backward control area ends.

Optionally, the processor is further configured to perform at least one of the following:

adjusting a forward turning angle of the virtual object according to a first lateral distance between a real-time position of a touch point and the forward control area when the second preset touch control operation which slides from the forward control area to the left or the right is detected; and

adjusting a backward turning angle of the virtual object according to a second lateral distance between the real-time position of the touch point and the backward control area when the second preset touch control operation which slides from the backward control area to the left is detected or the right.

According to the mobile terminal provided by the present application, the forward control area and the backward control area are provided on the graphical user interface. According to the detected different touch control operations performed on the above two control areas, the virtual object is controlled to move forward, move backward, turn left forward, turn right forward, turn left backward, and turn right backward, thereby providing the game user with control experience which is closer to that of steering a real vehicle in the game scenario, not confusing the game user with the common movement control operations of the biological virtual objects, and making it easier for new users to start playing.

In an alternative embodiment, the mobile terminal can further include one or more processors, and memory resources represented by the memory for storing instructions executable by the processing components, such as an application. The application stored in the memory can include one or more modules each corresponding to a set of instructions. Additionally, the processing components are configured to execute instructions to perform the method for controlling the virtual object described above.

The mobile terminal can further include: a power component, configured to perform power management for the mobile terminal; a wired or wireless network interface, configured to connect the mobile terminal to the network; and an input/output (I/O) interface. The mobile terminal can operate based on an operating system stored in the memory, such as Android, iOS, Windows, Mac OS X, Unix, Linux, FreeBSD or the like.

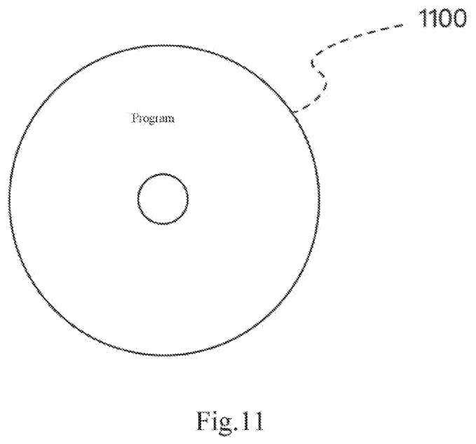

FIG. 11 is a schematic structural diagram of a computer storage medium according to an embodiment of the present disclosure. As shown in FIG. 11, a program product 1100 according to an embodiment of the present application on which a computer program is stored is illustrated, and when the computer program is executed by a processor, the following steps are implemented:

rendering a graphical user interface by performing a game application, wherein the graphical user interface includes a game scenario and at least one virtual object;

providing a forward control area and a backward control area on the graphical user interface; controlling the virtual object to move forward when a first preset touch control operation is detected on the forward control area; and controlling the virtual object to move backward when the first preset touch control operation is detected on the backward control area and

controlling the virtual object to turn left forward when a second preset touch control operation which slides from the forward control area to the left is detected; controlling the virtual object to turn right forward when the second preset touch control operation which slides from the forward control area to the right is detected; controlling the virtual object to turn left backward when the second preset touch control operation which slides from the backward control area to the left is detected; and controlling the virtual object to turn right backward when the second preset touch control operation which slides from the backward control area to the right is detected.

Optionally, a position of the forward control area on the graphical user interface is higher than that of the backward control area.

Optionally, a distance between the forward control area and the backward control area is within a preset distance range, and the preset distance range is configured to ensure that a user can touch and control with one hand.

Optionally, when the computer program is executed by a processor, the following step is implemented:

providing a visual prompt control on at least one of the forward control area, the backward control area, a left side of the forward control area, a right side of the forward control area, a left side of the backward control area, and a right side of the backward control area.

Optionally, when the computer program is executed by a processor, the following steps are implemented:

providing a forward visual prompt control in the forward control area; and

displaying a turning visual prompt control on the left and right sides of the forward control area, respectively, when a touch control operation in which at least part of touch points are located in the forward control area is detected.

Optionally, when the computer program is executed by a processor, the following step is implemented:

stopping the displaying of the turning visual prompt control when it is detected that the touch control operation in which at least part of the touch points are located in the forward control area ends.

Optionally, when the computer program is executed by a processor, the following steps are implemented:

providing a backward visual prompt control in the backward control area; and

displaying a turning visual prompt control on the left and right sides of the backward control area, respectively, when detecting a touch control operation in which at least part of the touch points are located in the backward control area.

Optionally, when the computer program is executed by a processor, the following step is implemented:

stopping the displaying of the turning visual prompt control when it is detected that the touch control operation in which at least part of the touch points are located in the backward control area ends.

Optionally, when the computer program is executed by a processor, at least one of the following steps is performed:

adjusting a forward turning angle of the virtual object according to a first lateral distance between a real-time position of the touch point and the forward control area when the second preset touch control operation which slides from the forward control area to the left or the right is detected; and

adjusting a backward turning angle of the virtual object according to a second lateral distance between the real-time position of the touch point and the backward control area when the second preset touch control operation which slides from the backward control area to the left is detected or the right.

According to the computer storage medium provided by the present application, the forward control area and the backward control area are provided on the graphical user interface. According to the detected different touch control operations performed on the above two control areas, the virtual object is controlled to move forward, move backward, turn left forward, turn right forward, turn left backward, and turn right backward, thereby providing the game user with control experience which is closer to that of steering a real vehicle in the game scenario, not confusing the game user with the common movement control operations of the biological virtual objects, and making it easier for new users to start playing.

The program codes embodied in a computer readable storage medium can be transmitted with any suitable media, including but not limited to wireless, wired, optical cable, radio frequency, etc., or any suitable combination of the foregoing.

Through the description of the above embodiments, those skilled in the art will readily understand that the exemplary embodiments described herein can be implemented in software or in a combination of software with necessary hardware. Therefore, the technical solutions according to embodiments of the present disclosure can be embodied in the form of a software product, which can be stored in a non-volatile storage medium (which may be a CD-ROM, a USB flash drive, a mobile hard disk, etc.) or on a network, and includes pieces of instructions to cause a computing device (which may be a personal computer, a server, a mobile terminal, a network device, or the like) to perform the methods in accordance with the embodiments of the present disclosure.

Other embodiments of the present disclosure will be apparent to those skilled in the art after considering the specification and practicing the disclosure disclosed herein. The present application is intended to cover any variation, use, or adaptation of the present disclosure, which follow the general principles of the present disclosure and include common general knowledge or conventional technical means in the art that are not disclosed in the present disclosure. The specification and embodiments are considered to be only illustrative, and the real scope and spirit of the present disclosure are defined by the claims.

It is to be understood that the present disclosure is not limited to the precise structures that have been described above and illustrated in the drawings, and can be modified and changed in various ways without departing from the scope thereof. The scope of the disclosure is to be limited only by the appended claims.

What is claimed is:

1. A method for controlling a virtual object, in which a graphical user interface comprising a game scenario and at least one virtual object is rendered by performing a game application, the method comprising:
providing a forward control area and a backward control area on the graphical user interface, controlling the virtual object to move forward when a first preset touch control operation is detected on the forward control area, and controlling the virtual object to move backward when the first preset touch control operation is detected on the backward control area; and
controlling the virtual object to turn left forward when a second preset touch control operation which slides from the forward control area to the left is detected, controlling the virtual object to turn right forward when the second preset touch control operation which slides from the forward control area to the right is detected, controlling the virtual object to turn left backward when the second preset touch control operation which slides from the backward control area to the left is detected, and controlling the virtual object to turn right backward when the second preset touch control operation which slides from the backward control area to the right is detected.

2. The method according to claim 1, wherein the forward control area is positioned over the backward control area on the graphical user interface.

3. The method according to claim 1, wherein a distance between the forward control area and the backward control area is within a preset distance range, and the preset distance range is configured to ensure that a user can touch and control with one hand.

4. The method according to claim 1, further comprising:
providing a visual prompt control on at least one of the forward control area, the backward control area, a left side of the forward control area, aright side of the forward control area, a left side of the backward control area, and a right side of the backward control area.

5. The method according to claim 1, further comprising:
providing a forward visual prompt control in the forward control area; and
displaying a turning visual prompt control on left and right sides of the forward control area, respectively, when a touch control operation in which at least part of touch points are located in the forward control area is detected.

6. The method according to claim 5, further comprising:
stopping the displaying of the turning visual prompt control when it is detected that the touch control operation in which at least part of the touch points are located in the forward control area ends.

7. The method according to claim 1, further comprising:
providing a backward visual prompt control in the backward control area; and
displaying a turning visual prompt control on left and right sides of the backward control area, respectively, when a touch control operation in which at least part of touch points are located in the backward control area is detected.

8. The method according to claim 7, further comprising:
stopping the displaying of the turning visual prompt control when it is detected that the touch control operation in which at least part of the touch points are located in the backward control area ends.

9. The method according to claim 1, further comprising at least one of the following:
adjusting a forward turning angle of the virtual object according to a first lateral distance between a real-time position of a touch point and the forward control area when the second preset touch control operation which slides from the forward control area to the left or to the right is detected; and
adjusting a backward turning angle of the virtual object according to a second lateral distance between the real-time position of the touch point and the backward control area when the second preset touch control operation which slides from the backward control area to the left is detected or to the right.

10. (canceled)

11. A mobile terminal, comprising:
a processor; and
a memory for storing instructions executable by the processor,
wherein, the processor is configured to:
render a graphical user interface including includes a game scenario and at least one virtual object by performing a game application;
provide a forward control area and a backward control area on the graphical user interface, control the virtual object to move forward when a first preset touch control operation is detected on the forward control area, and control the virtual object to move backward when the first preset touch control operation is detected on the backward control area; and
control the virtual object to turn left forward when a second preset touch control operation which slides from the forward control area to the left is detected, control the virtual object to turn right forward when the second preset touch control operation which slides from the forward control area to the right is detected, control the virtual object to turn left backward when the second preset touch control operation which slides from the backward control area to the left is detected, and control the virtual object to turn right backward when the second preset touch control operation which slides from the backward control area to the right is detected.

12. A non-transitory computer readable storage medium having stored thereon instructions which, when being executed by a processor, cause the processor to perform a method for controlling a virtual object, in which a graphical user interface comprising a game scenario and at least one virtual object is rendered by performing a game application, the method comprising:
providing a forward control area and a backward control area on the graphical user interface, controlling the virtual object to move forward when a first preset touch control operation is detected on the forward control area, and controlling the virtual object to move backward when the first preset touch control operation is detected on the backward control area; and
controlling the virtual object to turn left forward when a second preset touch control operation which slides from the forward control area to the left is detected, controlling the virtual object to turn right forward when the second preset touch control operation which slides from the forward control area to the right is detected, controlling the virtual object to turn left backward when the second preset touch control operation which slides from the backward control area to the left is detected, and controlling the virtual object to turn right backward when the second preset touch control operation which slides from the backward control area to the right is detected.

13. The storage medium according to claim 12, wherein the forward control area is positioned over the backward control area on the graphical user interface.

14. The storage medium according to claim 12, wherein a distance between the forward control area and the backward control area is within a preset distance range, and the preset distance range is configured to ensure that a user can touch and control with one hand.

15. The storage medium according to claim 12, further comprising:
providing a visual prompt control on at least one of the forward control area, the backward control area, a left side of the forward control area, a right side of the forward control area, a left side of the backward control area, and a right side of the backward control area.

16. The storage medium according to claim 12, further comprising:
providing a forward visual prompt control in the forward control area; and
displaying a turning visual prompt control on left and right sides of the forward control area, respectively, when a touch control operation in which at least part of touch points are located in the forward control area is detected.

17. The storage medium according to claim 16, further comprising:
stopping the displaying of the turning visual prompt control when it is detected that the touch control operation in which at least part of the touch points are located in the forward control area ends.

18. The storage medium according to claim 12, further comprising:
providing a backward visual prompt control in the backward control area; and
displaying a turning visual prompt control on left and right sides of the backward control area, respectively, when a touch control operation in which at least part of touch points are located in the backward control area is detected.

19. The storage medium according to claim 18, further comprising:
stopping the displaying of the turning visual prompt control when it is detected that the touch control operation in which at least part of the touch points are located in the backward control area ends.

20. The storage medium according to claim 12, further comprising at least one of the following:
adjusting a forward turning angle of the virtual object according to a first lateral distance between a real-time position of a touch point and the forward control area when the second preset touch control operation which slides from the forward control area to the left or to the right is detected; and
adjusting a backward turning angle of the virtual object according to a second lateral distance between the real-time position of the touch point and the backward control area when the second preset touch control operation which slides from the backward control area to the left is detected or to the right.
